(19) United States
(12) Patent Application Publication
(10) Pub. No.: US 2026/0075585 A1
(43) Pub. Date: Mar. 12, 2026

(54) SYSTEMS AND METHODS FOR OPTIMIZED PAGING USING TRAJECTORY PREDICTION

(71) Applicant: Verizon Patent and Licensing Inc., Basking Ridge, NJ (US)

(72) Inventors: Wei David Huang, Danville, CA (US); Vishwanath Ramamurthi, San Ramon, CA (US)

(21) Appl. No.: 18/830,903

(22) Filed: Sep. 11, 2024

(51) Int. Cl. H04W 68/02; H04W 52/02; H04W 64/00

(52) U.S. Cl. CPC H04W 68/02; H04W 52/0212; H04W 64/006

(57) ABSTRACT

Systems and methods described herein provide paging optimization using User Equipment (UE) trajectory prediction. A network device in a Radio Access Network (RAN) receives a paging request for an idle UE device. The network device generates a trajectory prediction for the idle UE device based on an inference model. The inference model predicts trajectories of UE devices, and the trajectory prediction includes a list of cells in the RAN where the idle UE device may be located. The network device maps the list of cells to a set of distributed units (DUs) for the RAN and initiates paging of the idle UE device using the set of DUs.

### BACKGROUND

New cellular networks (e.g., Fifth Generation (5G) networks) provide various services and applications to user devices connected via a radio access network (RAN). The user devices may be in various states of connection at any given time. For example, some user devices may have radio connections in an active state where data may be exchanged, and other user devices may be in an idle state. When in an idle state, a user device does not have an active communication path to the RAN. Paging procedures address this issue by alerting or paging the idle user device to re-establish a radio connection with the wireless network.

### BRIEF DESCRIPTION OF THE DRAWINGS

FIG. 1 is a diagram illustrating an exemplary environment in which embodiments may be implemented;

FIG. 2 is a diagram illustrating an architecture and communications for optimized paging using User Equipment (UE) device trajectory prediction based on artificial intelligence (AI)/machine learning (ML), according to an implementation;

FIG. 3 is a diagram illustrating example components of a paging optimization system, according to an implementation;

FIG. 4 is a diagram illustrating communications for implementing optimized paging using UE trajectory prediction, according to an implementation;

FIG. 5 is a diagram illustrating exemplary components of a device that may correspond to one or more of the devices illustrated and described herein; and

FIG. 6 is a flow diagram illustrating an exemplary process for providing optimized paging using UE trajectory prediction, according to an implementation.

### DETAILED DESCRIPTION

The following detailed description refers to the accompanying drawings. The same reference numbers in different drawings may identify the same or similar elements. Also, the following detailed description does not limit the invention.

The term "cell" as used herein is broadly construed as any signal area associated with an access device or other element of a radio access network (RAN) and may be used interchangeably with the term "sector." A cell or sector may be identified by a cell identifier (ID), such as an extended Cell Global Identifier (eCGI) or New Radio (NR) Cell Global Identifier (NCGI).

User Equipment (UE) devices, including mobile communication handsets (e.g., smart phones) and Internet of things (IoT) devices, may be in various states of connection at any given time. A Radio Resource Control (RRC) idle state is a low-activity state that is designed to conserve UE battery life and manage UE mobility without active communication with the RAN. In the RRC idle state, a UE does not actively engage in data transfer but can receive system information and paging messages.

Paging messages may be used for network-initiated connection setup when a UE device is in a RRC idle state. A paging message is typically transmitted across multiple cells in a tracking area or in a RAN notification area for a UE device. A UE device in an idle state, upon receiving a paging message, checks if the paging message contains the identity of the UE device in question. If so, the UE device may initiate a procedure to move from an idle state to a connected state. If a network paging attempt is unsuccessful, repeated attempts at different scales will be attempted.

Systems and methods described herein provide an optimized paging service using UE device trajectory prediction. The optimized paging service may be applied to a wireless environment. For example, the wireless environment may include a 5G wireless environment, and/or a future generation wireless environment, as described herein.

According to an exemplary embodiment, a radio access network (RAN) device may include logic of the optimized paging service, as described herein. For example, the RAN device may include a RAN intelligent controller (RIC) or similar type of RAN device (e.g., base station controller or the like), which may control or manage other RAN devices, such as an eNB, a gNB, a future generation wireless station, and/or the like.

According to an implementation, optimized paging is provided using UE trajectory prediction. A RAN device receives a paging request for an idle UE device. The RAN device generates a trajectory prediction for the idle UE device based on an inference model. The inference model predicts trajectories of UE devices, and the trajectory prediction includes a list of cells in the RAN where the idle UE device may be located. The RAN device maps the list of cells to a set of distributed units (DUs) for the RAN and initiates paging of the idle UE device using the set of DUs.

Paging procedures that efficiently deliver paging messages (e.g., a successful first paging attempt) can reduce paging wait times and call setup latency. Efficient paging attempts may also minimize radio channel interference and noise. Minimizing paging attempts may also result in UE devices spending less time and device energy monitoring and listening to paging signals over the air interface.

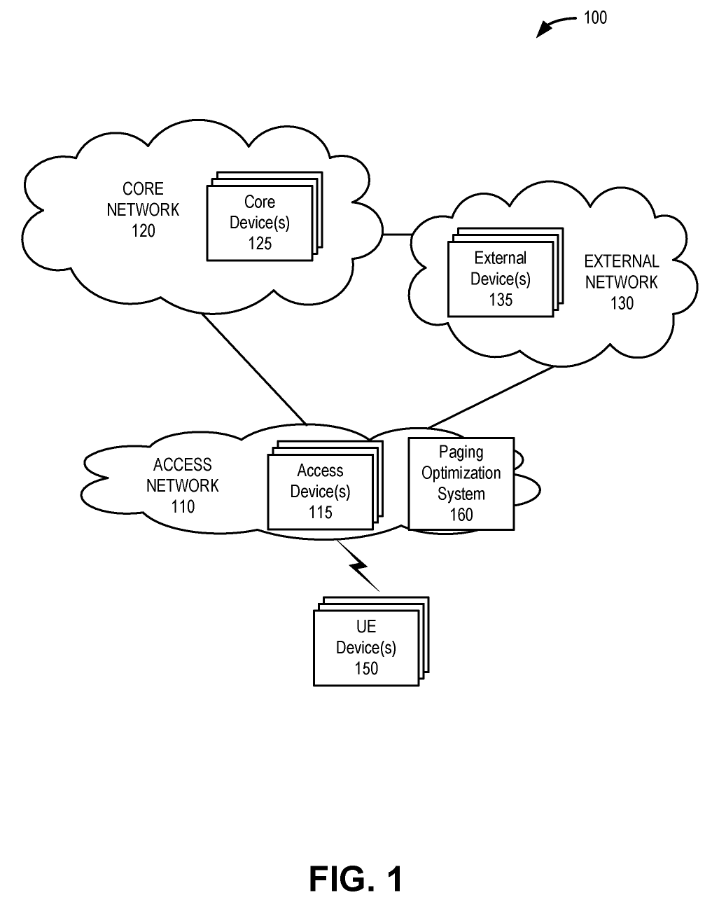

FIG. 1 is a diagram illustrating an environment 100 in which an embodiment of the optimized paging service may be implemented. As illustrated, environment 100 includes an access network 110, an external network 120, and a core network 120. Access network 110 includes access devices 115 (also referred to individually or generally as access device 115). Core network 120 includes core devices 125 (also referred to individually or generally as core device 125). External network 130 includes external devices 135 (also referred to individually or generally as external device 135). Environment 100 further includes UE devices 150 (also referred to individually or generally as UE device 150) and a paging optimization system 160.

The number, type, and arrangement of networks illustrated in environment 100 are exemplary. For example, according to other embodiments, environment 100 may include fewer networks, additional networks, and/or different networks. For example, according to other implementations, other networks not illustrated in FIG. 1 may be included, such as an X-haul network (e.g., backhaul, mid-haul, fronthaul, etc.), a transport network (e.g., Signaling System No. 7 (SS7), etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A connection via a communication link may be direct or indirect. For example, an indirect connection may involve an intermediary device and/or an intermediary network not illustrated in FIG. 1. A direct connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of optimized paging with UE trajectory prediction may use at least one of these planes of communication.

Access network 110 may include one or multiple networks of one or multiple types and technologies. For example, access network 110 may be implemented to include a 5G RAN, a future generation RAN (e.g., a Sixth Generation (6G) RAN, a Seventh Generation (7G) RAN, or a subsequent generation RAN), a centralized-RAN (C-RAN), a virtualized-RAN (vRAN), an Open-RAN (O-RAN), and/or another type of access network. Access network 110 may include a legacy RAN (e.g., a Third Generation (3G) RAN, a 4G or 4.5 RAN, etc.). Access network 110 may communicate with and/or include other types of access networks, such as, for example, a WI-FI network (e.g., using IEEE 802.11 standards), a Worldwide Interoperability for Microwave Access (WiMAX) network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 110.

Access network 110 may include different and multiple functional splitting, such as options 1, 2, 3, 4, 5, 6, 7, or 8 that relate to combinations of access network 110 and core network 120 including an Evolved Packet Core (EPC) network and/or an NG core (NGC) network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA new radio (NR), SA NR, etc.).

According to some implementations, access network 110 may be implemented to include various architectures of wireless service, such as, for example, macrocell, microcell, femtocell, picocell, metrocell, NR cell, LTE cell, non-cell, or another type of wireless architecture. Additionally, according to various exemplary embodiments, access network 110 may be implemented according to various wireless technologies (e.g., Radio Access Technologies (RATs), etc.), and various wireless standards, frequencies, bands, and segments of radio spectrum (e.g., centimeter (cm) wave, millimeter (mm) wave, below 6 gigahertz (GHz), above 6 GHz, higher than mm wave, C-band, licensed radio spectrum, unlicensed radio spectrum, above mm wave), and/or other attributes or technologies used for radio communication. Additionally, or alternatively, according to some exemplary embodiments, access network 110 may be implemented to include various wired and/or optical architectures for wired and/or optical access services.

Depending on the implementation, access network 110 may include one or multiple types of network devices, such as access devices 115. For example, access device 115 may include a gNB, an eLTE eNB, an eNB, a radio network controller (RNC), a RIC, a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a WI-FI device, a WiMax device, a hotspot device, a fixed wireless access CPE (FWA CPE), etc.) that provides a wireless access service. Additionally, access devices 115 may include a wired and/or an optical device (e.g., modem, wired access point, optical access point, Ethernet device, multiplexer, etc.) that provides network access and/or transport service.

According to some implementations, access device 115 may include a combined functionality of multiple RATs (e.g., 4G and 5G functionality, 5G and 5.5G functionality, etc.) via soft and hard bonding based on demands and needs. According to some exemplary implementations, access device 115 may include a split access device (e.g., a CU-control plane (CP), a CU-user plane (UP), etc.) or an integrated functionality, such as a CU-CP and a CU-UP, or other integrations of split RAN nodes. Access device 115 may be an indoor device or an outdoor device.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation, core network 120 may include diverse types of core devices 125. Core devices 125 may include, for example, a user plane function (UPF), a Non-3GPP Interworking Function (N3IWF), an access and mobility management function (AMF), a session management function (SMF), a unified data management (UDM) device, a unified data repository (UDR), an authentication server function (AUSF), a security anchor function (SEAF), a network slice selection function (NSSF), a network repository function (NRF), a policy control function (PCF), a network data analytics function (NWDAF), a network exposure function (NEF), a mobility management entity (MME), a packet data network gateway (PGW), and/or a serving gateway (SGW).

According to other exemplary implementations, core devices 125 may include additional, different, and/or fewer network devices than those described. For example, core devices 125 may include a non-standard or a proprietary network device, and/or another type of network device that may be well-known but not particularly mentioned herein. Core devices 125 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes. Also, core devices 125 may include a split core device 125. For example, core devices 125 may include a session management (SM) PCF, an access management (AM) PCF, a user equipment (UE) PCF, and/or another type of split architecture associated with another core device 125, as described herein.

External network 130 may include one or multiple networks of one or multiple types and technologies that provide an application service. For example, external network 130 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 130 may be implemented to include a cloud network, a private network, a public network, a Multi-access Edge Computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 130 may include various network devices, such as external devices 135. For example, external devices 135 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by UE devices 150. By way of further example, external devices 135 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 130 may include one or multiple types of core devices 125, as described herein.

External devices 135 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 135 may also include other types of network devices that support the operation of external network 130 and the provisioning of application services, such as an orchestrator, an edge manager, an operations support system (OSS), a local domain name system (DNS), registries, and/or external devices 135 that may pertain to various network-related functions (e.g., security, management, charging, billing, authentication, authorization, policy enforcement, development, etc.). External devices 135 may include non-virtual, logical, and/or physical network devices.

UE device 150 may include a device that has communication capabilities (e.g., wireless, wired, optical, etc.). UE device 150 may or may not have computational capabilities. UE device 150 may be implemented as a mobile device, a portable device, a stationary device (e.g., a non-mobile device and/or a non-portable device), a device operated by a user, or a device not operated by a user. For example, UE device 150 may be implemented as a smartphone, a mobile phone, a personal digital assistant, a tablet, a netbook, a wearable device (e.g., a watch, glasses, headgear, a band, etc.), a computer, a gaming device, a television, a set top box, a music device, an IoT device, a drone, a smart device, a fixed wireless device, a router, a sensor, an automated guided vehicle (AGV), an industrial robot, or other type of wireless device (e.g., another type of end device).

UE device 150 may be configured to execute various types of software (e.g., applications, programs, etc.). For example, UE device 150 may include paging response logic. When UE device 150 in an RRC idle state (also referred to as an "idle UE device") receives a paging message, the paging response logic checks if the paging message contains the identity of UE device 150 and, if so, initiates a procedure to move from an idle state to a connected state. The number and the types of software may vary among UE devices 150. For purposes of description, UE device 150 is not considered a network device. UE device 150 may be implemented as a virtualized device in whole or in part.

As further shown in FIG. 1, paging optimization system 160 may be included in access network 110. One or more aspects of paging optimization system 160 may be implemented, for example, by an access device 115 (e.g., a RIC device and/or gNB). According to an exemplary embodiment, at least some of access devices 115 may include logic of an exemplary embodiment of the optimized paging service. For example, a RIC, an RNC, a BSC, or similar type of network device that may manage, control, and/or configure a cellular wireless station of access network 110 (referred to herein simply as a RIC device) may provide the optimized paging service.

According to an exemplary embodiment, paging optimization system 160 may provide predicted trajectories of UE device to more efficiently direct paging messages, as described further herein. According to some embodiments, paging optimization system 160 may obtain historical cell use information and other types of network information, as described herein, from a network management device or similar network device that may monitor network devices, communication links, user plane traffic, UE devices 150, and/or the like.

According to an exemplary embodiment, paging optimization system 160 may calculate the UE trajectories based on an ML/AI component. According to an embodiment, the ML/AI component may include logic that creates, trains, re-trains, tunes, and/or updates a model (e.g., an AI model, an ML model, a learning-based model, a custom model, a prediction model, etc.) using visited cell history information (e.g., historical, current, prospective, etc.), other network information, an ML algorithm, an AI algorithm, a deep learning algorithm, or another type of learning algorithm, as described herein. According to various exemplary implementations, the learning algorithm may include a supervised learning algorithm, an unsupervised learning algorithm, and/or a reinforcement learning algorithm. The ML/AI component may include logic that includes predictive analytics. For example, the ML/AI component may include a model that may be implemented as a Support Vector Machine, a Decision Tree, a Neural Network, Naïve Bayes, Random Forest, another type of learning-based algorithm, and/or a non-learning-based algorithm/rule-based logic.

According to an exemplary embodiment, at least some other access devices 115 may include logic of an exemplary embodiment of paging optimization system 160. For example, a gNB, an eNB, an eLTE eNB, or another type of wireless station may provide aspects of the optimized paging service. In one implementation, model training function may reside in a non- real time (RT) RIC (e.g., in a Service Management and Orchestration (SMO) framework) and an inference model function may reside in a CU or near-RT RIC.

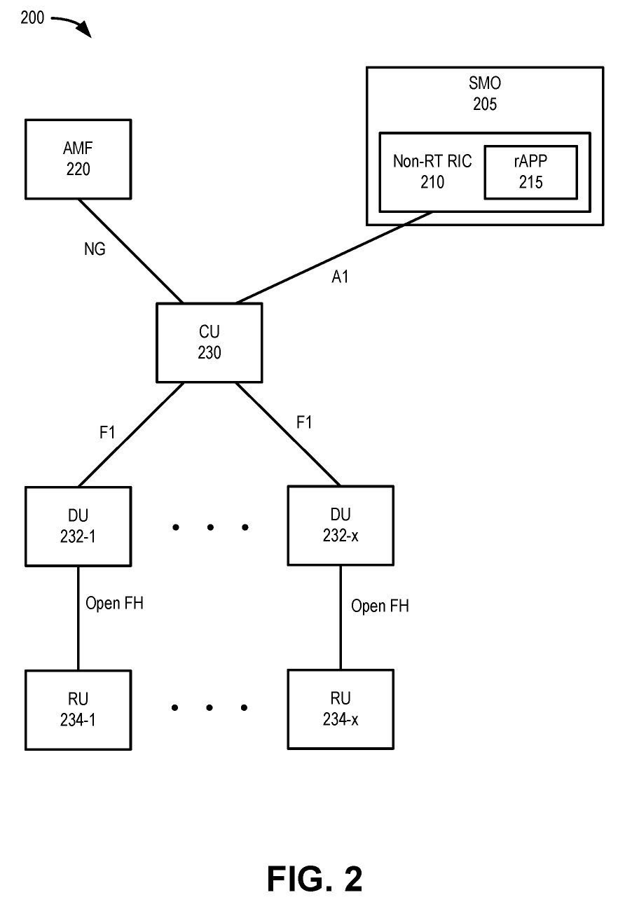

FIG. 2 is a diagram illustrating a portion 200 of network environment 100 that includes aspects of the systems and methods described herein. As shown in FIG. 2, network portion 200 may include an SMO framework 205 with a non-RT RIC 210, an AMF 220, a CU 230, DUs 232-1 through 232-x (also referred to collectively as DUs 232 and individually as DU 232), and RUs 234-2 through 234-x (also referred to collectively as RUs 234 and individually as RU 234).

Non-RT RIC 210 may be part of a RIC system that uses AI-enabled policies and ML-based models to optimize network performance. The RIC system may include a near-real time RIC (not shown) and non-RT RIC 210. The near-RT RIC and non-RT RIC 210 may be implemented as functional layers of a single component (e.g., a single RIC device) or as separate components. For example, as shown in FIG. 2, non-RT RIC 210 may be included in SMO framework 205. In contrast, a near-RT RIC may be included within a gNB, for example.

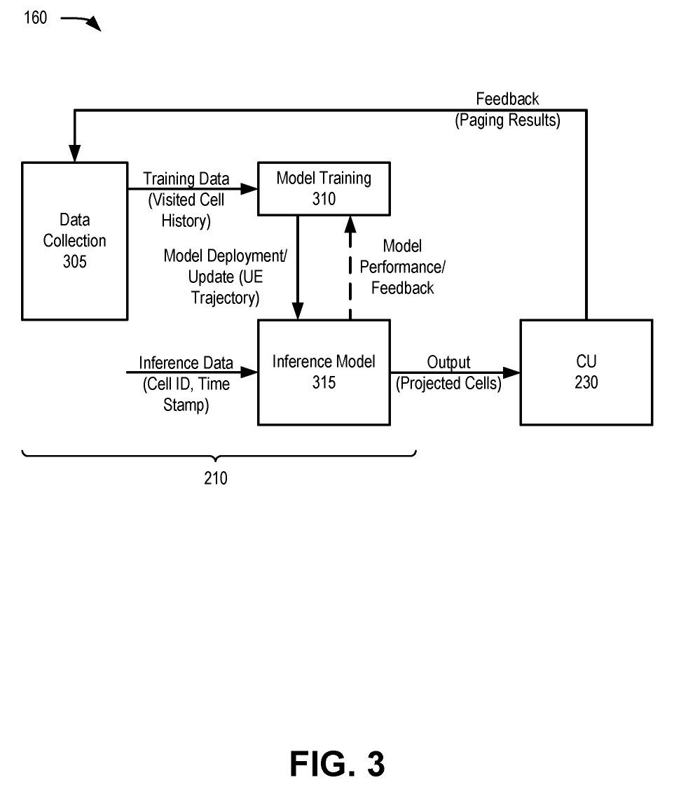

As shown in FIG. 2, non-RT RIC 210 may execute a non-real time Application (rApp) 215. Generally, an rApp provides a specialized microservice for a non-real-time RIC as defined under the O-RAN Alliance. According to implementations described herein, rApp 215 may perform AI/ML based UE trajectory prediction for the paging optimization service. For example, rAPP 215 may include one or more of the functional components of paging system 160 described in FIG. 3. As described further below in connection with FIG. 3, rApp 215 may collect UE device history and train an AI/ML UE trajectory prediction model. Using the trained model, rApp 215 may generate a list of predicted cells where an idle UE device 150 may be located.

AMF 220 may perform UE-based authentication, authorization, and mobility management for UE devices 150. AMF 220 may correspond to, for example, one of core devices 125. In relation to the paging optimization service, AMF 220 may initiate an N2 paging procedure by providing a paging message to CU 230. The paging message may include a last-visited cell ID for the UE device being paged and a time stamp of the last visit to the cell.

CU 230 may include a central unit for a gNB or another access device 115. In one implementation, CU 230 may conform to standards for an O-CU. CU 230 may control the transport of data (e.g., data packets) received via wireless RF transmissions from a UE device 150 and may control the transport of data from a wireless network to a DU 232 for wireless transmission (e.g., via RU 234) to a destination UE device 150. CU 230 may be associated with multiple DUs 232. In some implementations, CU 230 may be divided into control plate (CP) and user plane (UP) components. The CU-CP includes a logical node that hosts Radio Resource Control (RRC) and other control plane functions (e.g., Service Data Adaptation Protocol (SDAP), Packet Data Convergence Protocol (PDCP), etc.). The CU-UP includes a logical node that hosts user plane functions, such as, for example, data routing and transport functions. In relation to the paging optimization service, CU 230 may, in response to a paging request from AMF 220, request a list of predicted cells from non-RT RIC 210. CU 230 may receive a list of predicted cells, map the predicted cells to DUs 232 for those cells, and then send paging commands to selected DUs 232. CU 230 ay also collect and report paging success feedback and provide feedback to non-RT RIC 210 for model fine tuning/improvement.

DU 232 may, in some implementations, include a logical node that hosts functions associated with the Radio Link Control layer, the Medium Access Control (MAC) layer, and the physical layer (PHY). In one implementation, DU 232 may conform to standards for an O-DU. In some implementations, the DU 232 may host a scheduler for managing use of physical resources for uplink and downlink signaling over a corresponding RU 234. Under direction of CU 230, DU 232 may send paging signals to initiate communications with a UE device 150 in idle mode. DU 232 may collect and report paging success results to CU 230.

FIG. 3 illustrates an example of a functional framework of paging optimization system 160 for generating and applying trajectory models. The framework of paging optimization system 160 may be included, for example, within a portion of access network 110, such as non-RT RIC 210, or core network 120. In one implementation, paging optimization system 160 may be distributed among one or more access devices 115.

As shown in FIG. 3, a data collection component 305 may receive and store data relevant to a particular machine learning objective, such as UE history info to support the paging optimization service. Data collection component 305 may provide a predetermined data set (e.g., training data) for model training 310. For the paging optimization service, collected data may include, for example, a list of cells where each UE device 150 has camped and the duration of stay at each of the cells.

Model training 310 may use a deep neural network to learn how to analyze the training data and make inferences, such as inferences for UE trajectory prediction. Model training 310 may eventually generate an inference model 315 to which new data (e.g., inference data) for UE trajectory prediction may be applied. For example, inference data may include a UE device's last visited cell ID and a time stamp/duration.

In some implementations, one or more components of inference model 315 may include machine learning models, such as a deep learning neural network and/or another type of neural network. The inference model may include multiple layers of nodes (or neurons) with a certain arrangement of connections between the nodes. Weights (i.e., numerical values) may be associated with the connections between the nodes. Each connection between nodes may have an associated weight that signifies a strength and direction (e.g., positive or negative) of the influence one node has on another. In other implementations, inference model 315 may include a K-nearest neighbors (KNN) classifier, a decision tree classifier, a naïve Bayes classifier, a support vector machine (SVM) classifier, tree based (e.g., a random forest) classifier using Euclidian and/or cosine distance methods, a logistic regression classifier, a linear discriminant analysis classifier, a quadratic linear discriminant analysis classifier, a maximum entropy classifier, a kernel density estimation classifier, a principal component analysis (PCA) classifier, a gradient boosting framework (e.g. XGBoost, LightGBM) and/or another type of classifier. Other configurations may be implemented.

Inference model 315 may receive inference data as input and provide an output to CU 230, such as a list of projected cells where a UE device 150 is expected to be. The output may be received by a CU 230 (e.g., a network actor), which may apply the output to manage network operations and/or configurations. CU 230 may provide feedback, such as paging results, to data collection component 305 to indicate, for example, the accuracy/results of the output.

While FIG. 3 illustrates an example arrangement of components for paging optimization system 160, in other implementations, components of paging optimization system 160 may be arranged differently. For example, in another implementation, model training 310 may reside in SMO framework 205/non-RT RIC 210, while inference model 315 may reside in CU 230 or a near-RT RIC.

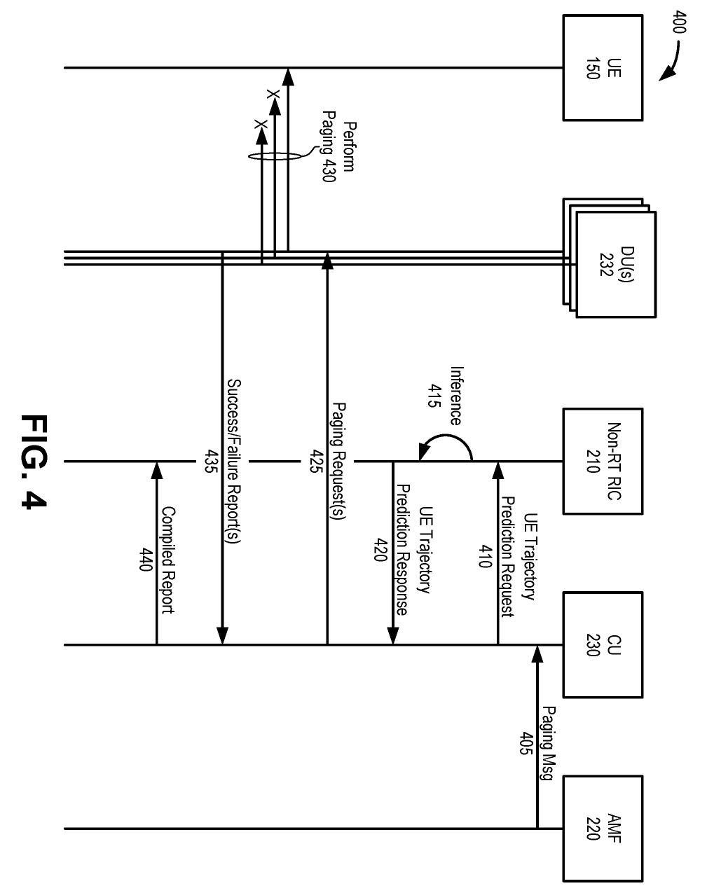

FIG. 4 is a diagram illustrating communications, in a portion 400 of network environment 100, to implement the paging optimization service. As shown in FIG. 4, network portion 400 may include UE device 150, non-RT RIC 210, AMF 220, CU 230, and one or more DUs 232. FIG. 4 provides simplified illustrations of communications in network portion 400 and are not intended to reflect every signal or communication exchanged between devices/functions.

As shown in FIG. 4, AMF 220 may send a paging message 405 to CU 230. For example, in response to a network request to reach a particular UE device 150, AMF 220 may send an N2 paging message via an NG interface. The paging message may include a last visited cell ID and a time stamp of when the UE device 150 was last at the cell.

CU 230 may receive paging message 405 from AMF 220 and, in response, generate a UE trajectory prediction request 410. UE trajectory prediction request 410 may include the cell ID and time stamp from paging message 405. CU 230 may send UE trajectory prediction request 410 to non-RT RIC 210 via, for example, an A1 interface.

Non-RT RIC 210 may receive UE trajectory prediction request 410 and apply the cell ID and time stamp to an inference model (e.g., inference model 315) to generate an inference 415, such as a list of cells where UE device 150 may be located. For example, based on the cell ID and time stamp in UE trajectory prediction request 410, non-RT RIC 210 may identify a list of cells (e.g., 3 cells, 5 cells, 12 cells, or more) where UE device 150 is most likely to be located. Non-RT RIC 210 may send the list of cells to CU 230 as UE trajectory prediction response 420. Non-RT RIC 210 may send UE trajectory prediction response 420 to CU 230 via, for example, an A1 interface.

CU 230 may receive UE trajectory prediction response 420. Based on the predicted cells and the last visited cell, CU 230 may identify a list of DUs 232 for optimized paging. For example, CU 230 may map the cell IDs from UE trajectory prediction response 420 to specific DUs 232 (e.g., network addresses of specific DUs 232). Thus, CU 230 may identify a subset of all the DUs 232 that are managed by CU 230 and send a paging request 425 to that subset of DUs 232. The number of DUs 232 in the subset may be smaller, for example, than a number of DUs for a typical tracking area or RAN notification area that would otherwise be used for paging procedures. CU 230 may send a paging request 425 to the selected DUs 232 via, for example, an F1 interface.

In response to paging request 425, each of the DUs 232 may perform paging 430 of UE device 150 via an air interface. As indicated in FIG. 4, paging 430 by DUs 232 may be successful or unsuccessful at different corresponding cells.

Each of DUs 232 may provide paging success or failure reports 435 to CU 230. Reports 435 may include, for example, a result (e.g., indicating success/fail), time stamps, and a cell ID for each paging attempt. CU 230 may receive reports 435 and assemble them into a compiled report 440. Compiled report 440 may be provided to non-RT RIC 210. In another implementation, CU 230 may forward individual reports 435 to non-RT RIC 210 at period intervals. Non-RT RIC 210 may use reports 435 or compiled report 440 for model training or calibration of inference model 315.

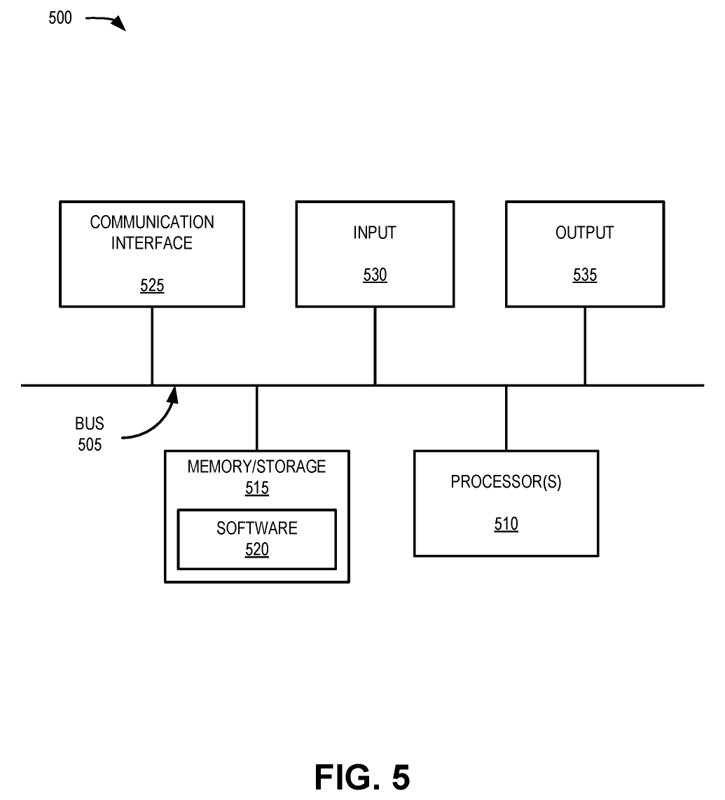

FIG. 5 is a diagram illustrating exemplary components of a device 500 that may be included in one or more of the devices described herein. For example, device 500 may correspond to elements of access devices 115, core devices 125, external devices 135, UE device 150, paging optimization system 160, and/or other types of network devices, as described herein. As illustrated in FIG. 5, device 500 includes a bus 505, a processor 510, a memory/storage 515 that stores software 520, a communication interface 525, an input 530, and an output 535. According to other embodiments, device 500 may include fewer components, additional components, different components, and/or a different arrangement of components than those illustrated in FIG. 5 and described herein.

Bus 505 includes a path that permits communication among the components of device 500. For example, bus 505 may include a system bus, an address bus, a data bus, and/or a control bus. Bus 505 may also include bus drivers, bus arbiters, bus interfaces, clocks, and so forth.

Processor 510 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 510 may be implemented as hardware (e.g., a microprocessor, etc.), a combination of hardware and software (e.g., a SoC, an ASIC, etc.), may include one or multiple memories (e.g., cache, etc.), etc.

Processor 510 may control the overall operation or a portion of operation(s) performed by device 500. Processor 510 may perform one or multiple operations based on an operating system and/or various applications or computer programs (e.g., software 520). Processor 510 may access instructions from memory/storage 515, from other components of device 500, and/or from a source external to device 500 (e.g., a network, another device, etc.). Processor 510 may perform an operation and/or a process based on various techniques including, for example, multithreading, parallel processing, pipelining, interleaving, etc.

Memory/storage 515 includes one or multiple memories and/or one or multiple other types of storage mediums. For example, memory/storage 515 may include one or multiple types of memories, such as, a random access memory (RAM), a dynamic random access memory (DRAM), a static random access memory (SRAM), a cache, a read only memory (ROM), a programmable read only memory (PROM), an erasable PROM (EPROM), an electrically EPROM (EEPROM), a single in-line memory module (SIMM), a dual in-line memory module (DIMM), a flash memory (e.g., 2D, 5D, NOR, NAND, etc.), a solid state memory, and/or some other type of memory. Memory/storage 515 may include a hard disk (e.g., a magnetic disk, an optical disk, a magneto-optic disk, a solid-state disk, etc.), a Micro-Electromechanical System (MEMS)-based storage medium, and/or a nanotechnology-based storage medium. Memory/storage 515 may include drives for reading from and writing to the storage medium.Memory/storage 515 may store data, software, and/or instructions related to the operation of device 500.

Software 520 includes an application or a program that provides a function and/or a process. Software 520 may also include firmware, middleware, microcode, hardware description language (HDL), and/or other form of instruction. Software 520 may also be virtualized. Software 520 may further include an operating system (OS) (e.g., Windows, Linux, Android, proprietary, etc.).

Communication interface 525 permits device 500 to communicate with other devices, networks, systems, and/or the like. Communication interface 525 includes one or multiple wireless interfaces and/or wired interfaces. For example, communication interface 525 may include one or multiple transmitters and receivers, or transceivers (e.g., RF transceivers). Communication interface 525 may operate according to a protocol stack and a communication standard. Communication interface 525 may include an antenna. Communication interface 525 may include various processing logic or circuitry (e.g., multiplexing/de-multiplexing, filtering, amplifying, converting, error correction, API, etc.). Communication interface 525 may be implemented as a point-to-point interface, a service-based interface, or a reference interface, for example.

Input 530 permits an input into device 500. For example, input 530 may include a keyboard, a mouse, a display, a touchscreen, a touchless screen, a button, a switch, an input port, speech recognition logic, and/or some other type of visual, auditory, tactile, etc., input component. Output 535 permits an output from device 500. For example, output 535 may include a speaker, a display, a touchscreen, a touchless screen, a light, an output port, and/or some other type of visual, auditory, tactile, etc., output component.

As previously described, a network device may be implemented according to various computing architectures (e.g., in a cloud, edge, etc.) and according to various network architectures (e.g., a virtualized function, etc.). Device 500 may be implemented in the same manner. For example, device 500 may be instantiated, created, deleted, or be in some other operational state during its life-cycle (e.g., refreshed, paused, suspended, rebooting, or another type of state or status), using well-known virtualization technologies (e.g., hypervisor, container engine, virtual container, virtual machine, etc.) in an application service layer network (e.g., a MEC network) and/or another type of network.

Device 500 may perform a process and/or a function, as described herein, in response to processor 510 executing software 520 stored by memory/storage 515. By way of example, instructions may be read into memory/storage 515 from another memory/storage 515 (not shown) or read from another device (not shown) via communication interface 525. The instructions stored by memory/storage 515 cause processor 510 to perform a process described herein. Alternatively, for example, according to other implementations, device 500 performs a process described herein based on the execution of hardware (processor 510, etc.).

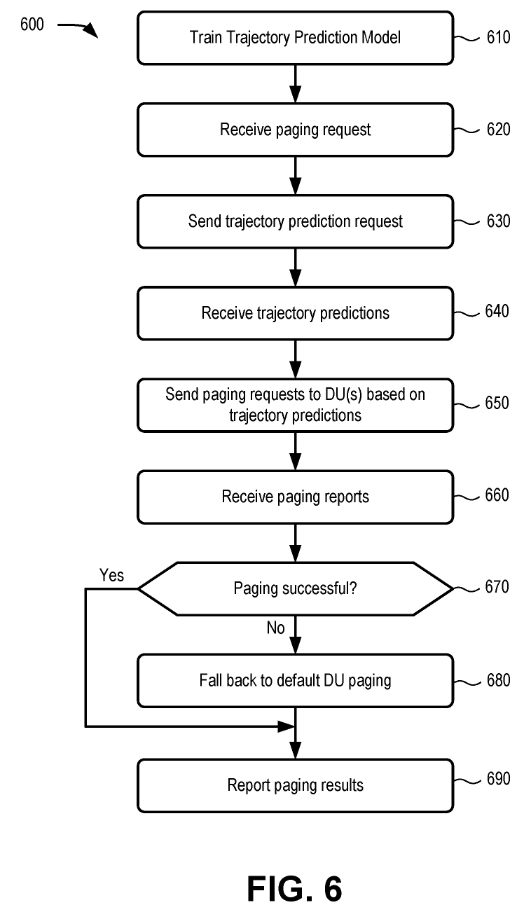

FIG. 6 is a flow diagram illustrating a process 600 for implementing paging optimization using UE trajectory prediction. According to an implementation, process 600 may be performed, for example, by CU 230 implementing paging optimization system 160. In other implementations, process 600 may be performed by CU 230 in conjunction with non-RT RIC or other devices or functions in network portion 200.

Process 600 may include training a trajectory prediction model (block 610). For example, paging optimization system 160 may generate an inference model based on historical data of cells visited by UE devices 150. In one implementation, paging optimization system 160 may be included in non-RT RIC 210. In other implementations, some or all of paging optimization system 160 may be included with a near-RT RIC or CU 230. As described above in connection with FIG. 3, model training 310 may generate an inference model 315 to which new data (e.g., inference data) for UE trajectory prediction may be applied.

Process 600 may also include receiving a paging request (block 620) and sending a trajectory prediction request (block 630). For example, as described above in connection with FIG. 4, CU 230 may receive paging message 405 from AMF 220 and, in response, generate a UE trajectory prediction request 410. The UE trajectory prediction request may include a cell ID and time stamp for a last visited cell by UE device 150.

Process 600 may further include receiving trajectory predictions (block 640) and sending paging requests to one or more DUs based on the trajectory predictions (block 650). For example, based on a trajectory request from CU 230, non-RT RIC 210 may apply the cell ID and time stamp to an inference model (e.g., inference model 315) to generate a list of cells where UE device 150 may be located. As described in FIG. 4, non-RT RIC 210 may send the list of cells to CU 230 as UE trajectory prediction response 420. CU 230 may receive UE trajectory prediction response 420 and identify a list of DUs 232 that correspond to the cells. CU 230 may send a paging request 425 to the corresponding DUs 232.

Process 600 may additionally include receiving paging reports (block 660) and determining if the paging was successful (block 670). For example, as shown in FIG. 4, each of the DUs 232 may perform paging 430 of UE device 150. Each of DUs 232 may provide paging success or failure reports 435 to CU 230. Based on the reports, CU 230 may determine if any of the paging messages successfully reached UE device 150.

If the paging was not successful (block 670 - No), process 600 may include falling back to a default DU paging set (block 680). For example, if reports from DUs 232 indicate that UE device 150 was not successfully pages, CU 230 may re-try paging procedures with a default set of DUs for paging (e.g., all DUs 232 in a region, regardless of direction).

If the paging was successful (block 670 - Yes) or after falling back to the default DU paging set, process 600 may include reporting the paging results (block 690). For example, CU 230 may assemble reports from DUs 232 into a compiled report. The compiled report 440 may be provided to non-RT RIC 210, a near-RT RIC, or another device that manages the models for paging trajectory system 160.

As set forth in this description and illustrated by the drawings, reference is made to "an exemplary embodiment," "an embodiment," "embodiments," etc., which may include a particular feature, structure or characteristic in connection with an embodiment(s). However, the use of the phrase or term "an embodiment," "embodiments," etc., in various places in the specification does not necessarily refer to all embodiments described, nor does it necessarily refer to the same embodiment, nor are separate or alternative embodiments necessarily mutually exclusive of other embodiment(s). The same applies to the term "implementation," "implementations," etc.

The foregoing description of embodiments provides illustration, but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms "a," "an," and "the" are intended to be interpreted to include one or more items. Further, the phrase "based on" is intended to be interpreted as "based, at least in part, on," unless explicitly stated otherwise. The term "and/or" is intended to be interpreted to include any and all combinations of one or more of the associated items. The word "exemplary" is used herein to mean "serving as an example." Any embodiment or implementation described as "exemplary" is not necessarily to be construed as preferred or advantageous over other embodiments or implementations.

In addition, while series of communications have been described with regard to FIGS. 3 and 4 and series of blocks have been described with regard to the processes illustrated in FIG. 6, the order of the communications and blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as "logic," a "component," or an "element." The logic, the component, or the element, may include, for example, hardware, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as "first," "second," "third," etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 510) of a device. A non-transitory storage medium includes one or more of the storage mediums described in relation to memory/storage 515. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, it should be understood that such information shall be collected, stored, and used in accordance with all applicable laws concerning protection of personal information. Additionally, the collection, storage and use of such information can be subject to consent of the individual to such activity, for example, through well known "opt-in" or "opt-out" processes as can be appropriate for the situation and type of information. Collection, storage and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method comprising:
generating an inference model for predicting trajectories of User Equipment (UE) devices;
receiving a paging request for an idle UE device;
generating a trajectory prediction for the idle UE device based on the inference model, wherein the trajectory prediction includes a list of cells in a Radio Access Network (RAN) where the idle UE device may be located;
mapping the list of cells to a set of distributed units (DUs) for the RAN; and
paging the idle UE device using the set of DUs.

2. The method of claim 1, further comprising:
receiving, from each DU in the set of DUs, a paging report, wherein the paging report indicates a success or failure of the paging; and
forwarding the paging reports for improvement of the inference model.

3. The method of claim 1, wherein receiving the paging request includes:
receiving a last visited cell identifier and a time stamp for the idle UE device.

4. The method of claim 3, wherein generating the trajectory prediction further includes:
generating a trajectory prediction for the idle UE device based on the last visited cell identifier and the time stamp.

5. The method of claim 1, wherein generating the inference model includes:
generating, by a non-real-time RAN intelligent controller (RIC), a trained model based on visited cell histories of the idle UE.

6. The method of claim 1, wherein generating the trajectory prediction further includes:
receiving, from an access and mobility management function (AMF), the paging request that includes a last visited cell identifier and a time stamp for the idle UE device;
sending, to a non-real-time RAN intelligent controller (RIC), a trajectory prediction request that includes the last visited cell identifier and the time stamp; and
applying, by the non-real-time RIC, the last visited cell identifier and the time stamp to the inference model.

7. The method of claim 1, wherein receiving the paging request includes:
receiving the paging request by a centralized unit (CU) for the RAN.

8. The method of claim 7, further comprising:
determining, by the CU, that paging of the idle UE device was not successful; and
performing, by the CU, another paging procedure with a different set of DUs when the paging of the idle UE device was not successful.

9. A radio access network (RAN) device comprising:
one or more processors configured to:
receive a paging request for an idle User Equipment (UE) device;
generate a trajectory prediction for the idle UE device based on an inference model, wherein the inference model predicts trajectories of UE devices, and wherein the trajectory prediction includes a list of cells in a Radio Access Network (RAN) where the idle UE device may be located;
map the list of cells to a set of distributed units (DUs) for the RAN; and
initiate paging of the idle UE device using the set of DUs.

10. The RAN device of claim 9, wherein the one or more processors are further configured to:
receive, from each DU in the set of DUs, a paging report, wherein the paging report indicates a success or failure of the paging; and
forward the paging reports for improvement of the inference model.

11. The RAN device of claim 9, wherein, when receiving the paging request, the one or more processors are further configured to:
receive a last visited cell identifier and a time stamp for the idle UE device.

12. The RAN device of claim 11, wherein, when generating the trajectory prediction, the one or more processors are further configured to:
generate a trajectory prediction for the idle UE device based on the last visited cell identifier and the time stamp.

13. The RAN device of claim 9, wherein, when generating the inference model, the one or more processors are further configured to:
generate a trained model based on visited cell histories of the idle UE.

14. The RAN device of claim 9, wherein, when generating the trajectory prediction, the one or more processors are further configured to:
receive, from an access and mobility management function (AMF), the paging request that includes a last visited cell identifier and a time stamp for the idle UE device; and
send, to a non-real time RAN intelligent controller (RIC), a trajectory prediction request that includes the last visited cell identifier and the time stamp.

15. The RAN device of claim 9, wherein the RAN device includes a centralized unit (CU) for the RAN.

16. The RAN device of claim 9, wherein the one or more processors are further configured to:
determine that paging of the idle UE device using the set of DUs was not successful; and
perform another paging procedure with a different set of DUs when the paging of the idle UE device using the set of DUs was not successful.

17. A non-transitory, computer-readable storage medium storing instructions, executable by a processor of a network device, for:
generating an inference model for predicting trajectories of User Equipment (UE) devices;
receiving a paging request for an idle UE device;
generating a trajectory prediction for the idle UE device based on the inference model, wherein the trajectory prediction includes a list of cells in a Radio Access Network (RAN) where the idle UE device may be located;
mapping the list of cells to a set of distributed units (DUs) for the RAN; and
paging the idle UE device using the set of DUs.

18. The non-transitory, computer-readable storage medium of claim 17, wherein the instructions are further for:
receiving, from each DU in the set of DUs, a paging report, wherein the paging report indicates a success or failure of the paging; and
forwarding the paging reports for improvement of the inference model.

19. The non-transitory, computer-readable storage medium of claim 17, wherein the instructions are further for:
determining that paging of the idle UE device was not successful; and
performing another paging procedure with a different set of DUs when the paging of the idle UE device was not successful.

20. The non-transitory, computer-readable storage medium of claim 17, wherein the paging request includes a last visited cell identifier and a time stamp for the idle UE device.
